(19) United States
(12) Patent Application Publication
(10) Pub. No.: US 2026/0206814 A1
(43) Pub. Date: Jul. 23, 2026

(54) PROCESS FOR STIMULATING GLP-1 PRODUCTION

(71) Applicant: Green Gourmet A/S, Randers NV (DK)

(72) Inventors: Ulla Andersen, Randers NV (DK); Yuan Yue, Randers NV (DK)

(73) Assignee: Green Gourmet A/S, Randers NV (DK)

(21) Appl. No.: 19/144,278

(22) PCT Filed: Dec. 29, 2023
(86) PCT No.: PCT/EP2023/087950

§ 371 Date: Jun. 27, 2025

(30) Foreign Application Priority Data
Dec. 30, 2022 (DK) PA 2022 01230

(51) Int. Cl. A23L 33/22; A23L 19/00

(52) U.S. Cl. CPC A23L 33/22; A23L 19/09

(57) ABSTRACT

The present invention relates to a process for providing a dried product comprising a plant material selected from a Brassica oleracea species, the process comprises the steps of (i) providing the plant material selected from a Brassica oleracea species; (ii) optionally cleaning the plant material provided in step (i) providing a cleaned plant material; and (iii) drying the plant material provided in step (i) or the cleaned plant material provided in step (ii), providing a dried plant material; wherein the drying in step (iii) is performed under conditions where the energy applied to dry the plant material is provided as a pulsed treatment.

### TECHNICAL FIELD OF THE INVENTION

The present invention relates to a process for providing a composition comprising a plant material selected from a Brassica oleracea species. In particular the present invention relates to a process for providing a composition comprising a plant material selected from a Brassica oleracea species showing improved medical effects, e.g. like type 2 diabetes, obesity and cholesterol.

### BACKGROUND OF THE INVENTION

Plants, has been used in traditional medicine practices since prehistoric times. Plants synthesize hundreds of chemical compounds for various functions, including defense and protection against insects, fungi, diseases, and herbivorous mammals

Therefore, as the result of years of optimization by nature, various plant materials may be perfectly suited to provide biological macromolecules like fibres, proteins, nucleic acids, organic acid, and other metabolites providing health benefits to the consumer. All sources of natural products such as plants, microorganisms, animals, etc. may therefore be of potential biomedical relevance to elucidate cellular mechanisms and modulate their functioning to the needs of modern medicine.

The plant material selected from a Brassica oleracea species may include many common cultivars used as vegetables, such as cabbage, broccoli, cauliflower, kale, Brussels sprouts, collard greens, Savoy cabbage, kohlrabi, and gai lan.

The Brassica oleracea species has established as an important human food crop plant, used because of its large food reserves, which are stored over the winter in its leaves.

The Brassica oleracea species has shown to have enhanced beneficial effects against key factors associated with type-2 diabetes and obesity.

Obesity is one of the major health problems with high prevalence worldwide. Yet, the current pharmacological anti-obesity treatment has not been satisfying due to poor efficacy, high cost and considerable side effects.

During the last decade, many natural bioactive components in food are found to have anti-obesity properties and this possibility of controlling body weight by food ingredients have been highlighted.

It has been described that food components are able to interact with enteroendocrine cells in the gastrointestinal tract and stimulate gut hormone glucagon-like peptide-1 (GLP-1) secretion, and thereby enhance satiety and reduce food intake

GLP-1 is one of the most important satiety hormones, and is secreted by enteroendocrine L-cells that are distributed throughout the small and large intestine. However, because of the rapid degradation of active GLP-1, its secretion is often measured by total GLP-1, which is the sum of active and inactive GLP-1.

Previous studies suggest that impaired GLP-1 function is a crucial contributor in obesity, and synthetic GLP-1 agonists are already used in obesity therapy. GLP-1 secretion can be stimulated by many nutrients and bioactive components like carbohydrates, proteins, fatty acids and polyphenols from plants.

In vivo, GLP-1 regulates glucose homeostasis by stimulating insulin secretion, inhibiting glucagon secretion, slowing gastric emptying, which will in turn enhance satiety, decrease food intake and lead to subsequent weight loss.

GLP-1 has shown to be highly potent on diabetes. The incretin effect, in which various metabolic hormones bring about reduced blood glucose levels, is thought to be triggered by a glucagon-like peptide. One of the major hormones responsible for stimulating this action is GLP-1, which is considered being the most effective in reducing high blood glucose levels.

Hence, an improved process for providing a composition capable of improving the stimulation of GLP-1 secretion would be advantageous, and in particular a more efficient and/or reliable process for providing a composition capable of improving the stimulation of GLP-1 secretion would be advantageous.

### SUMMARY OF THE INVENTION

Thus, an object of the present invention relates to present invention relates to a process for providing a composition comprising a plant material selected from a Brassica oleracea species. In particular the present invention relates to a process for providing a composition comprising a plant material selected from a Brassica oleracea species showing improved medical effects, e.g. like type 2 diabetes, obesity and cholesterol.

Thus, one aspect of the invention relates to a process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;

wherein the drying in step (iii) is performed under conditions where the energy applied to dry the plant material is provided as a pulsed treatment.

Another aspect of the present invention relates to a process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;

wherein the drying in step (iii) is performed under conditions where the temperature of the plant material during drying in step (iii) is kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. at 10° C. or below, such as at 5° C. or below.

Yet another aspect of the present invention relates to a composition comprising a plant material selected from a Brassica oleracea species, wherein the composition comprises an increased amount of sinapic acid relative to conventional compositions comprising plant material selected from a Brassica oleracea species.

Still another aspect of the present invention relates to a composition comprising a plant material selected from a Brassica oleracea species, wherein the composition is capable of increasing the production and/or secretion of Glucagon-like peptide-1 (GLP-1) determined by an in vitro assay by at least 25 pmol/l.

A further aspect of the present invention relates to a consumable product comprising a composition according to the present invention.

Yet an aspect of the present invention relates to a dietary supplement and/or a pharmaceutical product comprising a composition according to the present invention for the treatment or alleviation of obesity in a mammal.

Still an aspect of the present invention relates to a dietary supplement and/or a pharmaceutical product comprising a composition according to the present invention for controlling the glucose and/or insulin level in a mammal and/or alleviation of type-2 diabetes in a mammal.

The present invention will now be described in more detail in the following.

### DETAILED DESCRIPTION OF THE INVENTION

Accordingly, the inventor of the present invention surprisingly found that a special combination of feature would lead to the preservation of interesting metabolites in a plant material selected from a Brassica oleracea species

A preferred embodiment of the present invention relates to a process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;
   wherein the drying in step (iii) is performed under conditions where the energy applied to dry the plant material is provided as a pulsed treatment.

The temperature of the plant material during drying in step (iii) may be kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. at 10° C. or below, such as at 5° C. or below.

The pulsed treatment may include an alternating sequence of (a) a sequence of energy-applied followed by (b) a sequence of reduced-energy treatment or of energy-free treatment.

The pulsed treatment may involve a continuous alternation in energy applied to the plant material from a higher level of energy to a lower level of energy and vice versa (the lower level of energy being below the higher level of energy).

The change between the continuous alternating higher level of energy to a lower level of energy and vice versa may be performed for 2-200 times during the drying process, such as for 5-150 times, e.g. 7-100 times, such as for 10-75 times, e.g. 12-50 times, such as for 15-40 times, e.g. 20-35 times.

In an embodiment of the present invention the alternating between higher level of energy and lower level of energy may be provided by adding energy to the drying chamber of the dryer, preferably a freeze dryer. Preferably, the addition of energy to the drying chamber of the dryer, may be provided by addition of hot gas, such as host air.

Preferably, the temperature of the hot gas, such as hot air, may be kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. in the range of 10-60° C., such as in the range of 25-57° C., e.g. in the range of 35-56° C., such as in the range of 40-55° C., e.g. in the range of 45-50° C.

After some time in the drying chamber, the temperature of the hot air in the drying chamber may decrease resulting in a reduced temperature of the hot air.

After a predetermined time, the hot air with the reduced temperature may be removed from the drying chamber (this being the sequence with low level of energy).

Preferably, the hot air with the reduced temperature may be substituted with introduction with hot air (this being the sequence with higher level of energy).

The change between the alternating sequences of (a) a sequence of energy-applied followed by (b) a sequence of energy-free treatment and vice versa may be controlled according to a specified time interval and/or specified by a predetermined change in temperature in the drying chamber.

In an embodiment of the present invention the change between the alternating sequences of (a) a sequence of energy-applied followed by (b) a sequence of energy-free treatment may be controlled according to a specified time interval and/or specified by a predetermined change in temperature in the drying chamber.

In an embodiment of the present invention the predetermined change in temperature in the drying chamber may be between 0.1° C. and 25° C., such as between 0.2° C. and 20° C., e.g. between 0.3° C. and 18° C., such as between 0.4° C. and 15° C., e.g. between 0.5° C. and 12° C., such as between 0.6° C. and 10° C., e.g. between 0.7° C. and 6° C., such as between 0.8° C. and 5° C., e.g. between 0.9° C. and 4° C., such as between 1.0° C. and 3° C., e.g. between 1.5° C. and 2° C.

The higher level of energy may be provided in the form of heat during drying in step (iii) may be kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. at 10° C. or below, such as at 5° C. or below.

The plant material may be subjected to a reduced pressure relative to atmospheric pressure during drying. Preferably, the pressure during drying is below 1 mbar, such as below 0.8 mbar, e.g. below 0.6 mbar, such as below 0.4 mbar, e.g. below 0.3 mbar, such as below 0.2 mbar, e.g. below 0.1 mbar, such as below 0.09 mbar, e.g. below 0.07 mbar, such as below 0.05 mbar, e.g. below 0.03 mbar.

In an embodiment of the present invention the drying may preferably be freeze drying. The freeze drying according to the present invention may involve a primary drying or a primary drying and a secondary drying.

The moisture content of the dried plant material after primary drying may be in the range of 5-15% (w/w) water, such as in the range of 6-14% (w/w), e.g. in the range of 7-13% (w/w), such as in the range of 8-12% (w/w), e.g. in the range of 9-11% (w/w), such as about 10% (w/w).

The moisture content of the dried plant material after secondary drying may be in the range of 2-10% (w/w) water, such as in the range of 3-9% (w/w), e.g. in the range of 4-8% (w/w), such as in the range of 5-7% (w/w), e.g. in the range of 4-6% (w/w), such as about 5% (w/w).

A preferred embodiment of the present invention relates to a process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;

wherein the drying in step (iii) is performed under conditions where the temperature of the plant material during drying in step (iii) is kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. at 10° C. or below, such as at 5° C. or below.

The temperature during drying may be kept low by reducing the amount of energy provided during the drying process, and/or by the procedure of applying the energy during drying.

In a preferred embodiment of the present invention the energy provided for drying the plant material, may be applied as a pulsed treatment to reduce the drying effect on the plant material.

The Brassica oleracea species may preferably, be selected from Brassica oleracea acephala, Brassica oleracea laciniata, Brassica oleracea sabellica, Brassica oleracea capitata, or a combination hereof.

Preferably, the Brassica oleracea species may be selected from Brassica oleracea acephala.

The plant material provided in step (i) may consist essentially of Brassica oleracea species. The Brassica oleracea species may be selected from a Brassica oleracea acephala, Brassica oleracea laciniata, Brassica oleracea sabellica, Brassica oleracea capitata, or a combination hereof. Preferably, the Brassica oleracea species may be selected from Brassica oleracea acephala.

In the context of the present invention, the term “consisting essentially of” or “consist essentially of” may be used interchangeable and may relate to a limitation of the scope of a claim to the specified features or steps and those features or steps, not mentioned and that do not materially affect the basic and novel characteristic(s) of the claimed invention.

In an embodiment of the present invention wherein the cleaning process (in step (ii)) comprises a washing step of the plant material provided in step (i).

Preferably, the washing step may be performed with water and may remove microorganisms, dirt and other extraneous matter from the surface of the plant material. In some cases the washing may be extensive washing as the dirt and other extraneous matter may hide in the plant material structure. Extensive washing may include shaking, agitation, or hosing or flushing (hosing and flushing may preferably be done under conditions where the surface of the plant material is kept substantially intact.

The washing may be performed using one or more chemicals accepted in the food industry. The one or more chemical may include one or more salt which may be included in order to remove, inhibit or kill unwanted microorganisms and/or unwanted microbial growth.

In an embodiment of the present invention the plant material may be provided in step (i) within 7 days from harvest of the plant material, preferably within 5 days from harvest of the plant material, more preferably within 3 days from harvest of the plant material, even more preferably within 24 hours from harvest of the plant material, even more preferably within 20 hours from harvest of the plant material, even more preferably within 15 hours from harvest of the plant material, even more preferably within 12 hours from harvest of the plant material, even more preferably within 10 hours from harvest of the plant material, even more preferably within 8 hours from harvest of the plant material.

In a further embodiment of the present invention the plant material provided in step (i) and/or the cleaned plant material obtained in step (ii) may be cut before being subjected to drying in step (iii).

Preferably, the plant material may be cooled and/or frozen before being subjected to drying as defined in step (iii).

In an embodiment of the present invention the frozen plant material may be completely frozen.

The plant material may be frozen to a temperature of at least −10° C., such as at least −15° C., e.g. at least −20° C., such as at least −30° C., e.g. at least −40° C., such as at least −50° C., e.g. at least −60° C.

Preferably, the dried plant material obtained in step (iii) may be subjected to at least one step of disintegration providing a disintegrated plant material.

In an embodiment of the present invention the at least one disintegration of the dried plant material may involve milling of the dried plant material.

Disintegration or milling of the plant material may result in a powdered plant material.

The dried plant material may have a moisture content below 15% (w/w), such as below 12% (w/w); e.g. below 10% (w/w), such as below 8% (w/w); e.g. below 6% (w/w), such as below 5% (w/w); e.g. below 4% (w/w), such as below 3% (w/w); e.g. below 2% (w/w).

The powdered plant material may comprise a particle size (d50) of 5 mm or less, such as an average diameter of 4 mm or less, such as an average diameter of 3 mm or less, such as an average diameter of 2 mm or less, such as a particle size (d50) of 1 mm or less, such as an average diameter in the range 25 μm to 5 mm, such as 0.1 mm to 4 mm, such as an average diameter in the range of 0.5 mm to 2.5 mm, such as an average diameter in the range 0.5 mm to 2 mm.

A preferred embodiment of the present invention relates to a composition comprising a plant material selected from a Brassica oleracea species, wherein the composition comprises an increased amount of sinapic acid relative to conventional compositions comprising plant material selected from a Brassica oleracea species.

Sinapic acid (or Sinapinic acid) is a small naturally occurring hydroxycinnamic acid found in plant materials. Sinapic acid (and its derivatives), along with other secondary metabolites, may be biosynthesized by plants via a set of chemical reactions. Without being bound by theory it is believed that these chemical reactions and the development or degradation may continue in the plant material after harvest.

The composition according to the present invention comprises sinapic acid (and derivatives hereof). Preferably, the composition according to the present invention comprises naturally occurring sinapic acid (and derivatives hereof).

Preferably, the plant material may be Brassica oleracea acephala and the composition may comprise an increased amount of sinapic acid relative to the other Brassica oleracea species.

The composition according to the present invention comprising a dried product, comprising a plant material selected from a Brassica oleracea species obtained according to the present invention, may comprise a higher content of sinapic acid relative a dried product, comprising a plant material selected from similar Brassica oleracea species, but obtained according to a conventional process.

The conventional process may include freeze drying of the harvested plant material where the plant material may reach a temperature above 70° C. and/or where the time from harvest to starting the process takes longer than 7 days.

Preferably, the Brassica oleracea species may be selected from Brassica oleracea acephala, Brassica oleracea laciniata, Brassica oleracea sabellica, Brassica oleracea capitata, or a combination hereof. Preferably, the Brassica oleracea species may be selected from Brassica oleracea acephala.

The composition according to the present invention may comprise an increased amount of sinapic acid. Preferably, the composition according to the present invention may comprise higher concentration of sinapic acid relative to other compositions of the prior art.

Preferably, the concentration of sinapic acid obtained in the composition of the present invention may be at least 10% higher than the content of sinapic acid in a composition of the prior art, such as at least 20% higher content of sinapic acid, e.g. at least 30% higher content, such as at least 40% higher content of sinapic acid, e.g. at least 50% higher content, such as at least 60% higher content of sinapic acid, e.g. at least 70% higher content, such as at least 80% higher content of sinapic acid, e.g. at least 90% higher content, such as at least 100% higher content of sinapic acid, e.g. at least 110% higher content.

Examples of compositions of the prior art may be:
compositions produced with maximum temperatures during drying above 60° C.;
compositions produced more than 5 days after harvest;
compositions produced under non-pulsed conditions during freeze-drying; and/or
compositions produced from species different from Brassica oleracea acephala.

The composition may preferably comprise a plant material selected from a Brassica oleracea species, wherein the composition may be capable of increasing the production and/or secretion of Glucagon-like peptide-1 (GLP-1) determined by an in vitro assay by at least 25 pmol/l.

A preferred embodiment of the present invention relates to a composition comprising a plant material selected from a Brassica oleracea species, wherein the composition is capable of increasing the production and/or secretion of Glucagon-like peptide-1 (GLP-1) determined by an in vitro assay by at least 25 pmol/l.

Preferably, the in vitro assay for determining the production of or content of GLP-1 may be described by Yue et al. (2019), and/or according to the process as described in the examples of the present invention.

The composition according to the present invention may preferably be capable of increasing the production and/or secretion of Glucagon-like peptide-1 (GLP-1) in a mammal. Preferably, the mammal may be a human or a pet and/or a farm animal.

In an embodiment of the present invention the composition comprising a plant material selected from a Brassica oleracea species, wherein the composition comprises an increased amount of sinapic acid relative to conventional compositions comprising plant material selected from a Brassica oleracea species and wherein the composition is capable of increasing the production and/or secretion of Glucagon-like peptide-1 (GLP-1) determined by an in vitro assay by at least 25 pmol/l.

In an embodiment, the composition according to the present invention consists essentially of a plant material selected from the Brassica oleracea species, preferably a Brassica oleracea species according to the present invention.

Brassica oleracea species, may be an annual plant grown from seed with a wide range of germination temperatures.

Raw Brassica oleracea, may comprise about 84% water, about 9% carbohydrates, about 4% protein, and about 1% fat. In a 100 g serving, raw Brassica oleracea provides about 207 kilojoules (49 kilocalories) of food energy, a large amount of vitamin K (about 3.7 times the daily recommended value). It is generally a rich source of vitamins and minerals (about 20% or more of the daily recommended value), such as vitamin A, vitamin C, vitamin B6, folate, and manganese. Raw Brassica oleracea may also be a good source of thiamin, riboflavin, pantothenic acid, vitamin E and several dietary minerals, including iron, calcium, magnesium, potassium, and phosphorus (covering about 10-19% of the daily recommended value). When preparing raw Brassica oleracea, e.g. by boiling most of these nutrients may diminishes, while values for vitamins A, C, and K, and manganese remain substantial.

In an embodiment of the present invention the composition comprises a food energy value per 100 g serving below 75 Kcal, such as below 70 kcal, e.g. below 65 kcal, such as below 60 kcal, e.g. below 55 kcal, such as below 50 kcal, e.g. below 45 kcal, such as below 40 kcal, e.g. below 35 kcal.

Food energy value may be the chemical energy that animals (including humans) derive from consuming a food product to sustain metabolism, including muscular activity.

In an embodiment of the present invention the food energy value and/or the level of produced/secreted GLP-1 may be based on a 100 g serving.

Preferably, the composition according to the present invention may be capable of increasing the production and/or secretion of GLP-1 determined by an in vitro assay by at least 25 pmol/l and the composition comprises a food energy value below 75 Kcal, such as below 70 kcal, e.g. below 65 kcal, such as below 60 kcal, e.g. below 55 kcal, such as below 50 kcal, e.g. below 45 kcal, such as below 40 kcal, e.g. below 35 kcal.

Preferably, the in-vitro assay used to determine the GLP-1 secretion is described in Example 4.

The plant material according to the present invention may comprise the leafs, or the leaf and the stem of a plant material. Preferably, the plant material comprises the leafs of the present invention.

Preferably, the plant material according to the present invention does not comprise the seeds of Brassica oleracea species.

The production and/or secretion of GLP-1 may be increased by at least 25 pmol/l per gram dried plant material, determined on a dry matter basis, e.g. at least 50 pmol/l per gram dried plant material, such as at least 75 pmol/l, e.g. at least 100 pmol/l, such as at least 125 pmol/l, e.g. at least 150 pmol/l, such as at least 175 pmol/l, e.g. at least 200 pmol/l, such as at least 225 pmol/l, e.g. at least 250 pmol/l, such as at least 275 pmol/l, e.g. at least 300 pmol/l, such as at least 325 pmol/l, e.g. at least 350 pmol/l, such as at least 375 pmol/l, e.g. at least 400 pmol/l, such as at least 425 pmol/l, e.g. at least 450 pmol/l, such as at least 475 pmol/l, e.g. at least 500 pmol/l.

In an embodiment of the present invention wherein the composition comprises less than 1.5 g salt per 100 g dried plant material (or composition), such as less than 1.25 g salt per 100 g dried plant material (or composition), e.g. less than 1.00 g salt per 100 g dried plant material (or composition), such as less than 0.75 g salt per 100 g dried plant material (or composition), e.g. less than 0.50 g salt per 100 g dried plant material (or composition), such as less than 0.25 g salt per 100 g dried plant material (or composition), e.g. less than 0.10 g salt per 100 g dried plant material (or composition), such as less than 0.08 g salt per 100 g dried plant material (or composition), e.g. less than 0.07 g salt per 100 g dried plant material (or composition), such as less than 0.06 g salt per 100 g dried plant material (or composition).

Preferably, the composition according to the present invention may comprise a fibrous material. Preferably, the fibrous material may be obtained from the plant material defined herein.

In an embodiment of the present invention the fibrous material of the plant material may be maintained, or may be substantially maintained, in the dried plant material and/or in the composition according to the present invention.

In the present context the term “substantially maintained” relates to maintaining at least 25% (w/w) of the fibrous material; such as at least 50% (w/w); e.g. at least 75% (w/w); such as at least 90% (w/w); e.g. at least 95% (w/w); such as at least 98% (w/w); e.g. at least 99% (w/w).

The composition according to the present invention may comprise in the range of 15-60 g fibrous material per 100 g dried plant material (or composition), such as in the range of 25-55 g fibrous material per 100 g dried plant material (or composition), e.g. in the range of 35-50 g fibrous material per 100 g dried plant material (or composition), such as in the range of 40-49 g fibrous material per 100 g dried plant material (or composition), e.g. in the range of 45-48 g fibrous material per 100 g dried plant material (or composition).

The composition according to the present invention may comprise in the range of 2-12 g fat per 100 g dried plant material (or composition), such as in the range of 4-10 g fat per 100 g dried plant material (or composition), e.g. in the range of 6-8 g fat per 100 g dried plant material (or composition).

The composition according to the present invention may comprise in the range of 5-25 g carbohydrate per 100 g dried plant material (or composition), such as in the range of 8-20 g carbohydrate per 100 g dried plant material (or composition), e.g. in the range of 10-15 g carbohydrate per 100 g dried plant material (or composition), such as in the range of 12-14 g carbohydrate per 100 g dried plant material (or composition).

The composition according to the present invention may comprise in the range of 5-30 g Protein per 100 g dried plant material (or composition), such as in the range of 10-28 g carbohydrate per 100 g dried plant material (or composition), e.g. in the range of 14-25 g carbohydrate per 100 g dried plant material (or composition), such as in the range of 16-22 g carbohydrate per 100 g dried plant material (or composition).

The composition according to the present invention consists essentially of a Brassica oleracea species. Preferably, the composition according to the present invention may consist essentially of a Brassica oleracea species selected from a Brassica oleracea acephala, Brassica oleracea laciniata, Brassica oleracea sabellica, Brassica oleracea capitata, or a combination hereof. Preferably, the composition according to the present invention may consist essentially of a Brassica oleracea species selected from a Brassica oleracea acephala.

In an embodiment of the present invention the increase in production and/or secretion of GLP-1 provided by the composition according to the present invention may be determined relative to the production and/or secretion of GLP-1 of a fasting state.

The Brassica oleracea species may be selected from Brassica oleracea acephala, Brassica oleracea laciniata, Brassica oleracea sabellica, Brassica oleracea capitata, or a combination hereof, and production and/or secretion of GLP-1 may be increased by at least 10% relative to a Brassica oleracea of a different species, such as at least 20%, e.g. at least 30%, such as at least 40%, e.g. at least 50%, such as at least 60%, e.g. at least 70%, such as at least 80%, e.g. at least 90%, such as at least 100%, e.g. at least 125% such as at least 150%, e.g. at least 175%, such as at least 200%, e.g. at least 250%.

In an embodiment of the present invention the present invention the Brassica oleracea species may be Brassica oleracea acephala, and production and/or secretion of GLP-1 may be increased by at least 10% relative to a Brassica oleracea species selected from Brassica oleracea laciniata, Brassica oleracea sabellica, and/or Brassica oleracea capitata, such as at least 20%, e.g. at least 30%, such as at least 40%, e.g. at least 50%, such as at least 60%, e.g. at least 70%, such as at least 80%, e.g. at least 90%, such as at least 100%, e.g. at least 125% such as at least 150%, e.g. at least 175%, such as at least 200%, e.g. at least 250%.

A preferred embodiment of the present invention relates to a consumable product comprising a composition according to the present invention.

The consumable product may be a beverage, a dry food product, a moisture food product or a dietary supplement.

The consumable product may be prepared for human consumption, or it may be prepared as a feed product for an animal. The animal may be a pet.

In an embodiment of the present invention wherein the dietary supplement may be provided in the form of a powder, a mixture (dry mixture or a wet mixture), a bar, or a gel.

The dietary supplement may be provided with one or more flavouring components, one or more binding components.

I preferred embodiment of the present invention relates to a pharmaceutical product comprising a plant material selected from Brassica oleracea species, wherein the composition is capable of increasing the production and/or secretion of GLP-1 by at least 25 pmol/l.

In a further preferred embodiment of the present invention relates to a dietary supplement and/or a pharmaceutical product comprising a composition according to the present invention for the treatment or alleviation of obesity in a mammal.

In a further preferred embodiment of the present invention relates to a dietary supplement and/or a pharmaceutical product comprising a composition according to the present invention for controlling one or more parameters relating to type-2 diabetes in a mammal.

In yet a further preferred embodiment of the present invention relates to a dietary supplement and/or a pharmaceutical product comprising a composition according to the present invention for controlling one or more parameters relating to type-2 diabetes in a mammal.

The one or more parameters relating to type-2 diabetes may include:
controlling the blood sugar level, in particular for patients suffering from type-2 diabetes; and/or
reducing the level of HbA1c (glycosylated hemoglobin).

In a preferred embodiment of the present invention relates to a dietary supplement and/or a pharmaceutical product comprising a composition according to the present invention for reducing the level og cholesterol, in particular LDL cholesterol, in a mammal.

Cholesterol is a fat substance. It's not inherently “bad” and the mammal body needs cholesterol to build cells and make vitamins and other hormones. However, too much cholesterol can pose a problem.

Cholesterol comes from two sources, from the liver which makes all the cholesterol needed; or from eating animal food products, like meat, poultry and dairy products, which all comprise dietary cholesterol.

Cholesterol may come as a low-density lipoprotein (LDL cholesterol) or a high-density lipoprotein (HDL cholesterol). The LDL cholesterol is considered to the un-healthy cholesterol and is undesirable in the blood.

When there is too much LDL (low-density lipoprotein) cholesterol in the blood, these particles can form deposits in the walls of the coronary arteries and other arteries throughout the body. Such deposits, called plaque, can narrow arteries and limit blood flow. When plaque breaks apart, it can cause a heart attack or stroke. Thus, there is a desire to reduce the level LDL cholesterol in the blood.

Preferably, the composition for treatment/alleviation of obesity, controlling one or more parameters relating to type-2 diabetes, and/or for reducing the cholesterol of a mammal may comprise a composition comprising a plant material selected from Brassica oleracea, wherein the composition may be capable of increasing the production and/or secretion of GLP-1 by at least 25 pmol/l.

In the context of the present invention, the term “comprising”, which may be synonymous with the terms “including”, “containing” or “characterized by” may relate to an inclusive or open-ended listing of features and does not exclude additional, unrecited features or process steps. The term “comprising” leaves the claim open for the inclusion of unspecified ingredients even in major amounts.

Since the inventor has shown that the content of sinapic acid may be increased by the process and the composition according to the present invention it is believed that the composition according to the present invention show to have an improved antioxidant, anti-hyperglycemic, and/or anti-lipidemic activity.

Sinapic acid may provide an anti-oxidant activity by scavenge free radicals and shows antioxidant activity, improves antioxidant status. This means a lot in various situation, as oxidative stress may be related to aging and many pathological processes, which may be postponed by the composition according to the present invention.

The anti-hyperglycemic activity (anti-diabetic activity) may be provided as the sinapic acid may decrease blood glucose e.g. by enhancing glucose utilization of the body and reducing insulin resistance, increasing insulin production, reducing food intake, and regulating the carbohydrate metabolism.

Sinapic acid may improve the anti-lipidemic activity, resulting in a reduction in the total cholesterol, triglycerides, LDL-cholesterol and increase HDL-cholesterol, by regulating cholesterol synthesis, thus maintain a normal lipid level in the body.

It should be noted that embodiments and features described in the context of one of the aspects of the present invention also apply to the other aspects of the invention.

The invention will now be described in further details in the following non-limiting examples.

### EXAMPLES

### Example 1—Preparation of the Dry Powder Plant Material According to the Present Invention

1 kg of Brassica oleracea acephala was harvested, washed with water, and cut into smaller pieces and subjected to freeze drying (lyophilization). The freeze drying process was conducted by a pulsed treatment where the plant material was subjected to an alternating sequence of (a) a sequence of energy-applied followed by (b) a sequence of energy-free treatment and vice versa.

During the entire freeze drying process the plant material maintained at a temperature below 42° C. by the pulsed treatment.

The resulting dry plant material had a moisture content of 5% (w/w) and was milled to a particle size d50 below 2 mm.

The period from harvest to dried and milled plant material was just about 8 hours.

### Example 2. Preparation of Various Dry Powders

Different types of powders are prepared by freeze drying according to the details presented in the table 1 below.

The starting point for each powder is the harvesting of 1 kg Brassica oleracea species followed by cleaning with water and cut into smaller pieces before being subjected to freeze drying (lyophilization) until a moisture content of 5% (w/w).

The resulting dry plant material was milled to a particle size d50 below 2 mm.

TABLE 1
Brassica oleracea species and process conditions
for preparing Brassica oleracea powders.

| | | Time from | Pulse/non-pulse | Maximum |
|---|---|---|---|---|
| | Brassica oleracea | harvest | treatment | temperature |
| | species | to powder | (freeze drying) | reached |
| Sample 1 | Acephala | 8 hours | Non-pulsed | 75° C. |
| Sample 2 | Sabellica | 8 hours | Non-pulsed | 75° C. |
| Sample 3 | Acephala | 8 hours | Pulsed | 42° C. |
| Sample 4 | Capitata | 8 hours | Pulsed | 42° C. |
| Sample 5 | Sabellica | 8 hours | Pulsed | 42° C. |
| Sample 6 | Acephala | 7 days | Non-Pulsed | 72° C. |
| Sample 7 | Acephala | 8 hours | Pulsed | 42° C. |

### Example 3—Determining the Content of Sinapic Acid in the Different Samples of Example 2

The 7 dried plant materials prepared in example 2 (sample 1 to sample 7) were tested for the content of sinapic acid. The content of sinapic acid was determined by the signal intensities obtained by spectrophotometric methods (LC/MC) and represent an average of replicates.

The following intensities were obtained

| | Signal intensity |
|---|---|
| Sample 1 | 6457051 |
| Sample 2 | 6535222 |
| Sample 3 | 17254219 |
| Sample 4 | 23708163 |
| Sample 5 | 26157482 |
| Sample 6 | 2253513 |
| Sample 7 | 38480833 |

Sample 7 showed to comprise a significant larger content of sinapic acid compared to the other samples.

Sample 6 showed a dramatic decrease in the content of sinapic acid and the reading was very low and uncertain.

The example also demonstrates that the pulsed treatment during freeze drying has a positive effect on the content of sinapic acid.

The Example also show that by adjusting the pulsed treatment to provide a maximum temperature of the plant material of 42° C. (sample 7) the content of sinapic acid may be further significantly increased, compared to a maximum temperature of 55° C. (sample 3).

The species Brassica oleracea acephala also showed to produce significant higher content of sinapic acid compared to Brassica oleracea capitata (sample 4) and Brassica oleracea sabellica (sample 5).

### Example 4—Determining the Potential in Inducing GLP-1 of the Different Samples of Example 2

The 7 dried plant materials prepared in example 2 (sample 1 to sample 7) were tested for the potential in inducing GLP-1. The results represent an average of 3 replicates.

The procedure for testing the potential in inducing GLP-1, the procedure described by Yue et al. (2019) was used.

The following contents of GLP-1 were observed

| | GLP-1 (pM) |
|---|---|
| Baseline | 18.26 |
| Sample 1 | 247.21 |
| Sample 2 | 233.91 |
| Sample 3 | 377.45 |
| Sample 4 | 307.20 |
| Sample 5 | 321.46 |
| Sample 6 | 256.47 |
| Sample 7 | 434.51 |

The improvement in the potential of inducing GLP-1 secretion also leads to an improvement in reducing food intake and improved insulin resistance, thereby improved stabilisation of blood glucose.

### REFERENCES

Yue et al. (2019): “Effect of food ingredients on glucagon-like peptide-1 in STC-1 and HuTu-80 cells”, International Journal of Food Science and Technology.

1. A process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;
wherein the drying in step (iii) is performed under conditions where the energy applied to dry the plant material is provided as a pulsed treatment.

2. A process for providing a dried product comprising a plant material selected from a Brassica oleracea species, the process comprises the steps of:
(i) providing the plant material selected from a Brassica oleracea species;
(ii) optionally cleaning the plant material provided in step (i) providing a cleaned plant material; and
(iii) drying the plant material provided in step (i) or the cleaned plant material provided in step (ii), providing a dried plant material;
wherein the drying in step (iii) is performed under conditions where the temperature of the plant material during drying in step (iii) is kept at 60° C. or below, such as at 55° C. or below, e.g. at 50° C. or below, such as at 45° C. or below, e.g. at 40° C. or below, such as at 35° C. or below, e.g. at 30° C. or below, such as at 25° C. or below, e.g. at 20° C. or below, such as at 15° C. or below, e.g. at 10° C. or below, such as at 5° C. or below.

3. A process according to anyone of claims 1-2, wherein the Brassica oleracea species is selected from Brassica oleracea acephala, Brassica oleracea laciniata, Brassica oleracea sabellica, Brassica oleracea capitata, or a combination hereof.

4. The process according to anyone of the preceding claims, wherein the plant material may be provided in step (i) within 7 days from harvest of the plant material, preferably within 5 days from harvest of the plant material, more preferably within 3 days from harvest of the plant material, even more preferably within 24 hours from harvest of the plant material, even more preferably within 20 hours from harvest of the plant material, even more preferably within 15 hours from harvest of the plant material, even more preferably within 12 hours from harvest of the plant material, even more preferably within 10 hours from harvest of the plant material, even more preferably within 8 hours from harvest of the plant material.

5. The process according to anyone of the preceding claims, wherein the dried plant material obtained in step (iii) may be subjected to at least one step of disintegration providing a disintegrated plant material.

6. A composition comprising a plant material selected from a Brassica oleracea species, wherein the composition comprises an increased amount of sinapic acid relative to conventional compositions comprising plant material selected from a Brassica oleracea species.

7. A composition comprising a plant material selected from a Brassica oleracea species, wherein the composition is capable of increasing the production and/or secretion of Glucagon-like peptide-1 (GLP-1) determined by an in vitro assay by at least 25 pmol/l.

8. the composition according to anyone of claims 6-7, wherein the composition comprises a food energy value per 100 g serving below 75 Kcal, such as below 70 kcal, e.g. below 65 kcal, such as below 60 kcal, e.g. below 55 kcal, such as below 50 kcal, e.g. below 45 kcal, such as below 40 kcal, e.g. below 35 kcal.

9. The composition according to anyone of claims 6-8, wherein the composition comprises less than 1.5 g salt per 100 g dried plant material, such as less than 1.25 g salt per 100 g dried plant material, e.g. less than 1.00 g salt per 100 g dried plant material, such as less than 0.75 g salt per 100 g dried plant material, e.g. less than 0.50 g salt per 100 g dried plant material, such as less than 0.25 g salt per 100 g dried plant material, e.g. less than 0.10 g salt per 100 g dried plant material, such as less than 0.08 g salt per 100 g dried plant material, e.g. less than 0.07 g salt per 100 g dried plant material, such as less than 0.06 g salt per 100 g dried plant material.

10. A consumable product comprising a composition according to anyone of claims 6-9.
